(19) United States
(12) Patent Application Publication
(10) Pub. No.: US 2005/0203997 A1
(43) Pub. Date: Sep. 15, 2005

(54) Data transceiving controlling apparatus

(75) Inventor: Zheng-Tie Sun, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/070,214

(22) Filed: Mar. 3, 2005

(30) Foreign Application Priority Data
Mar. 11, 2004 (TW) 93106556

(51) Int. Cl. G06F 15/16; G11B 7/085

(52) U.S. Cl. 709/203; 369/30.27

(57) ABSTRACT

The present invention discloses a data transceiving controlling apparatus including two transfer interfaces, a data registering unit and a controlling unit. One of the transfer interfaces is coupled to a transfer interface of a data storage device, and the other is coupled to a transfer interface of an optical disk drive. The data registering unit is for storing an outputted data from the data storage device. The controlling unit controls the data storage device on outputting the outputted data to the data registering unit, and controls the optical disk drive on recording the outputted data to a blank disk.

This application claims the benefit of Taiwan application Serial No. 93106556, filed Mar. 11, 2004, the subject matter of which is incorporated herein by reference.

### BACKGROUND OF THE INVENTION

1. Field of the Invention

The invention relates in general to a data transceiving controlling apparatus, and more particularly to a data transceiving controlling apparatus that controls an optical disk drive to record an outputted data from a storage device to a blank disk.

2. Description of the Related Art

With the advanced development of 3C (consuming electronics product, computer and communication) industries, disks with high storage capacity have been an important parts of modern data information carriers. Also, optical disk drives for reading or recording disks have been an important parts of modern life equipments.

For example, when users want to copy data of a CD to another blank disk, firstly, the CD and the blank CD have to be put into a CD-ROM drive and a CD-R drive respectively. The CD-ROM drive and the CD-R drive are coupled to a personal computer (PC). Then, a data copying command is given by the users. After the CPU of the PC received the data copying command, the CPU processes the recording into the blank CD in the CD-R drive according to the data of the CD in the CD-ROM drive, so that the data copying process is completed.

However, it is not convenient for users to copy data from a CD to another blank CD at any time and any is place, because the CD-ROM drive and the CD-R drive have to be coupled to a PC which is not easy to carry. Especially in such advanced development of multi-media trend, various multi-media storing apparatuses are provided in markets. Take a digital camera as an example, it is not convenient for users to transfer and record the data of the memory card of the digital camera when the storage capacity is full, because a CD-R drive and PC (even to laptop) are not so easy to carry all the time. Therefore, it is necessary to provide an apparatus capable of conveniently recording data without using a PC.

### SUMMARY OF THE INVENTION

It is therefore an object of the invention to provide a data transceiving controlling apparatus. The apparatus is detachably coupled to a data storage device and an optical disk drive via transfer interfaces such as USB or IEEE 1394 interfaces by plug-in/out, instead of being connected with a PC.

The invention achieves the above-identified object by providing a data transceiving controlling apparatus including two transfer interfaces, a data registering unit and a controlling unit. One of the transfer interfaces is coupled to a transfer interface of a data storage device, and the other is coupled to a transfer interface of an optical disk drive. The data registering unit is for storing an outputted data from the data storage device. The controlling unit controls the data storage device on outputting the outputted data to the data registering unit, and controls the optical disk drive on recording the outputted data to a blank disk.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a circuit block diagram showing the data transceiving controlling apparatus, the first optical disk drive and the second optical disk drive according to the first embodiment of the preferred embodiment of the invention.

FIG. 2 is a circuit block diagram showing the data transceiving controlling apparatus, the data storage device and an optical disk drive according to the second embodiment of the preferred embodiment of the invention.

### DETAILED DESCRIPTION OF THE INVENTION

### FIRST EXAMPLE

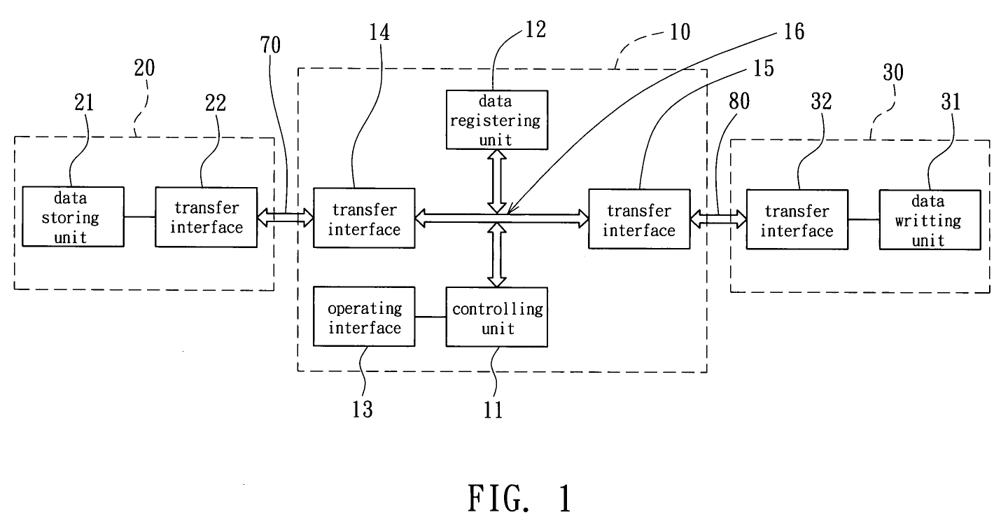

Referring to FIG. 1, it is a circuit block diagram showing the data transceiving controlling apparatus, the first optical disk drive and the second optical disk drive according to the first embodiment of the preferred embodiment of the invention. In FIG. 1, a data transceiving controlling apparatus 10 is used to controlling the second optical disk drive (CD-R) 30 on recording the outputted data from the first optical disk drive (CD-ROM) 20 to a blank disk. The data transceiving controlling apparatus 10 includes at least a controlling unit 11, a data registering unit 12, an operating interface 13, and two transfer interfaces 14 and 15. The first optical disk drive 20 at least includes a data reading unit 21 and a transfer interface 22 which is coupled therewith. The second optical disk drive 30 at least includes a data writing unit 31 and a transfer interface 32, which is coupled therewith.

The transfer interface 14 is detachably coupled to the transfer interface 22 by plug-in/out or via a cable 70 so that the data transceiving controlling apparatus 10 can control the first optical disk drive 20 on outputting an outputted data. The transfer interface 15 is detachably coupled to the transfer interface 32 by plug-in/out or via a cable 80 so that the data transceiving controlling apparatus 10 can control the second optical disk drive 30 on recording. The operating interface 13 is disposed on the surface of the case of the data transceiving controlling apparatus 10, and is used to being induced to output a data transfer writing command to the controlling unit 11. The controlling unit 11, the data registering unit 12, and the transfer interfaces 14 and 15 are electrically connected therebetween via a bus 16, and the controlling unit 11 is preferably a system on chip (SOC) or a microprocessor.

When the data transceiving controlling apparatus 10 is coupled to the first optical disk drive 20 and the second optical disk drive 30, the controlling unit 11 automatically detects that a disk is disposed in the first optical disk drive 20 and also detects the data format in the disk. Then, the operating interface 13 is induced by a user to output a data transfer writing command to the controlling unit 11. Next, the controlling unit 11 is received the data transfer writing command from the operating interface 13, and controls the data reading unit 21 on reading the disk. The data is read by the data reading unit 21 and outputted into the data registering unit 12 as the outputted data. The data registering unit 12 receives and stores the outputted data outputted from the first optical disk drive 20. The controlling unit 11 controls the second optical disk device 30 on receiving the outputted data stored in the data registering unit 12 so that the data writing unit 31 records the outputted data received by the second optical disk drive 30 to a blank disk.

In the first example of the preferred embodiments, the controlling unit 11 is under a data writing control program to control the optical disk drive 30 on directly recording data or recording after the data are transferred into different formants. Also, the data writing control program can be stored in a program registering unit, and the program registering unit is preferably a hard disk or a flask read only memory (Flash ROM).

However, the present invention is not limited to the above mentioned. For example, the transfer interfaces 14 and 15 can be two universal serial bus (USB) host interfaces, and the transfer interfaces 22 and 32 can two USB client interfaces, so that the data transceiving controlling apparatus 10 is a USB host, and the first optical drive 20 and the second optical disk writer 30 are two USB devices. Also, the transfer interfaces 14 and 15 can be two Serial ATA host interfaces, and the transfer interfaces 22 and 32 can two Serial ATA client interfaces. Or, the transfer interfaces 14, 15, 22 and 32 are four IEEE 1394 interfaces. The operating interface 13 is a button or a touch panel, and the data registering unit 12 is a hard disk or a random access memory (RAM). The first optical drive 20 is an optical disk drive selected from a group consisting of a CD-ROM, DVD-ROM, CD-R, DVD+R, DVD-R, CD-RW, DVD-RW, DVD+RW and DVD-RAM. The second optical disk drive 30 is an electrical device with recording function, such as CD-R, DVD+R, DVD-R, CD-RW, DVD-RW, DVD+RW and DVD-RAM.

### SECOND EXAMPLE

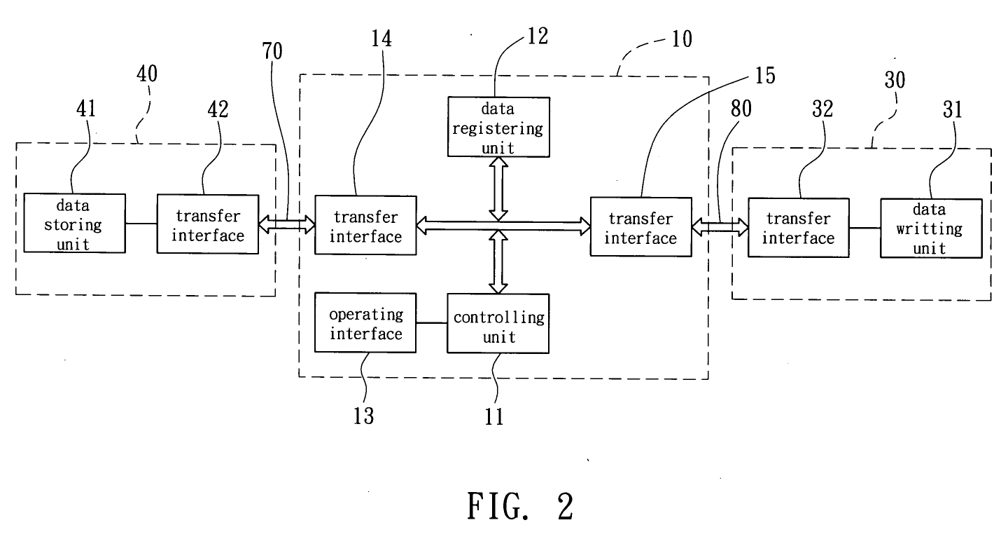

Referring to FIG. 2, it is a circuit block diagram showing the data transceiving controlling apparatus, the data storage device and an optical disk drive according to the second embodiment of the preferred embodiment of the invention. All components in the second example is similar to ones in the first example, and only one difference between the first example and the second example is that the data storage device 40. The data storage device 40 at least includes a data storing unit 41 and a transfer interface 42 which is coupled therewith. The data storing unit 41 can store data, and the transfer interface 42 is detachably coupled to the transfer 14 by plug-in/out or via a cable 70 so that the data transceiving controlling apparatus 10 can control the data storage device 40 on outputting the outputted data.

When the data transceiving controlling apparatus 10 is coupled to the data storage device 40 and the optical disk drive 30, the controlling unit 11 automatically detects the data format of the data storing unit 41. Then, the operating interface 13 is induced by a user to output a data transfer writing command to the controlling unit 11. Next, the controlling unit 11 is received the data transfer writing command from the operating interface 13, and controls the data storage device 40 on outputting the data of the data storing unit 41 into the data registering unit 12. The data registering unit 12 receives and stores the outputted data from the storage device 40. Or, the controlling unit 11 receives the outputted data in the data storing unit 41 and stores the outputted data in the data registering unit 12. Next, the controlling unit 11 controls the optical disk drive 30 on receiving the outputted data stored in the data registering unit 12 so that the data writing unit 31 records the outputted data received by the optical disk drive 30 to a blank disk.

However, the present invention is not limited to the above mentioned. For example, the data storage device 40 is selected from a group consisting of a digital camera, digital video recorder (DV), personal digital assistant (PDA), portable storage device, digital recorder, MP3 player, and cellular phone. The transfer interfaces 14 and 15 can be two universal serial bus (USB) host interfaces, and the transfer interfaces 22 and 32 can two USB client interfaces. Also, the transfer interfaces 14 and 15 can be two Serial ATA host interfaces, and the transfer interfaces 22 and 32 can two Serial ATA client interfaces. Or, the transfer interfaces 14, 15, 22 and 32 are four IEEE 1394 interfaces.

The data transceiving controlling apparatus disclosed in the preferred embodiments of the present invention is detachably coupled to a data output apparatus and an optical disk writer via transfer interfaces such as USB or IEEE 1394 interfaces by plug-in/out, instead of being connected with a PC. It does provide users more convenient and ease.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A data transceiving controlling apparatus, comprising:
a first transfer interface coupled to a second transfer interface of a data storage device;
a third transfer interface coupled to a fourth transfer interface of an optical disk drive;
a data registering unit for storing an outputted data from the data storage device; and
a controlling unit for controlling the data storage device on outputting the outputted data to the data registering unit, and controlling the optical disk drive on recording the outputted data to a blank disk.

2. The data transceiving controlling apparatus according to claim 1, wherein the first transfer interface and the third transfer interface are two universal serial bus (USB) host interfaces, and the second transfer interface and the fourth transfer interface are two USB client interfaces.

3. The data transceiving controlling apparatus according to claim 1, wherein the first transfer interface, the second transfer interface, the third transfer interface and the fourth transfer interface are four IEEE 1394 interfaces.

4. The data transceiving controlling apparatus according to claim 1, wherein the first transfer interface and the third transfer interface are two Serial ATA host interfaces, and the second transfer interface and the fourth transfer interface are two Serial ATA client interfaces.

5. The data transceiving controlling apparatus according to claim 1, wherein the controlling device further comprises an operating interface, being induced to output a data transfer writing command to the controlling unit, wherein the controlling unit controls the data outputting apparatus on outputting the outputted data to the data registering unit and controls the optical disk drive on recording the outputted data to the blank disk when the controlling unit receives the data transfer writing command.

6. The data transceiving controlling apparatus according to claim 5, wherein the operating interface is a button.

7. The data transceiving controlling apparatus according to claim 5, wherein the operating interface is a touch panel.

8. The data transceiving controlling apparatus according to claim 1, wherein the data registering unit is a random access memory (RAM).

9. The data transceiving controlling apparatus according to claim 1, wherein the data storage device is a specific optical drive including a data reading unit coupled to the second transfer interface, and the controlling unit controls the data reading unit on reading a disk having the outputted data so as to have the data reading unit output the outputted data to the data registering unit.

10. The data transceiving controlling apparatus according to claim 9, wherein the specific optical disk drive is an optical disk drive selected from a group consisting of a CD-ROM, DVD-ROM, CD-R, DVD+R, DVD-R, CD-RW, DVD-RW, DVD+RW and DVD-RAM.

11. The data transceiving controlling apparatus according to claim 1, wherein the data storage device includes a data storing unit coupled to the second transfer interface, the data storing unit stores the outputted data, and the controlling unit controls the data storage device on outputting the outputted data from the data storing unit to the data registering unit.

12. The data transceiving controlling apparatus according to claim 11, wherein the data storage device is selected from a group consisting of a digital camera, digital video recorder (DV), personal digital assistant (PDA), portable storage device, digital recorder, MP3 player, and cellular phone.
